(19) United States
(12) Patent Application Publication
(10) Pub. No.: US 2002/0012422 A1
(43) Pub. Date: Jan. 31, 2002

(54) Logger machine and logger equipment using the same

(76) Inventor: Kazuhiro Kashiwagi, Tokyo (JP)

Correspondence Address: Richard P. Gilly, Richard P. Gilly Intellectual Property Law Offices, One Penn Center - Suite 1500, 1617 John F. Kennedy Boulevard, Philadelphia, PA, 19103-1815, US

(21) Appl. No.: 09/785,054

(22) Filed: Feb. 16, 2001

(30) Foreign Application Priority Data
Jul. 28, 2000 (JP) 228406/2000

(51) Int. Cl. H04M 1/64

(52) U.S. Cl. 379/67.1

(57) ABSTRACT

Logger equipment, which is connected with transmission medium means of digital communication information, capable of recording speaking information of speaking machine, is provided.

Logger machine 1 is directly connected with transmission medium means 9 of packet method so as to receive packets on the transmission medium means 9. On the basis of the address information in the received packets, the packet of the speaking information by speaking machines TL3, TL4 is detected, and voice, image for instance can be recorded by recording the detected packet.

### FIELD OF THE INVENTION

This invention relates to a logger machine which records, searches and plays back conversation with a telephone and the like, and logger equipment using the same.

### DESCRIPTION OF THE PRIOR ART

A logger is a machine for recording conversation with a telephone and the like, and searching and playing back the recorded conversation when it should be confirmed later. FIG. 1 is a conceptual figure showing conventional logger equipment. As shown in FIG. 1, a telephone set TLa, a public telephone line 2 and a private telephone switching machine 7 are connected with one another through a telephone line 4. A plurality of telephone sets, such as telephone sets TLb and TLc, are connected with the private telephone switching machine 7 through an extension telephone line 4a. A logger 8 for recording conversation is connected with the extension telephone line 4a. For instance, the conversation between a telephone set TLa and a telephone set TLb is passed through the public telephone line 2, the telephone line 4, the private telephone switching machine 7 and the extension telephone line 4a. The conversation is detected and recorded as voice information by the logger 8 connected with the extension telephone line 4a. The recorded voice information can be searched and played back by various parameters, such as date, time and extension number.

As a telephone, an IP telephone connected with information communication network, such as Internet, without connecting with a telephone line (or an extension telephone line), is now widespreading. But, it is impossible to apply a conventional logger equipment in order to record the voice of IP telephone due to big difference in transmission method.

### OBJECT OF THE INVENTION

Then, the object of the present invention is to provide logger equipment, which is connected with transmission medium means of digital communication information, capable of recording speaking information of a speaking machine.

### SUMMARY OF THE INVENTION

The invention of claim 1 is logger machine, with which communication machine, which is comprised of speaking machine capable of transmitting and receiving digital speaking information and non-speaking machine capable of transmitting and receiving digital non-speaking information, is connected, to be connected with transmission medium means, capable of transmitting digital communication information, such logger machine comprising:

information receiving means for receiving digital communication information transferred from said transmission medium means;

speaking information discriminating means for discriminating said digital speaking information from said digital communication information received by said information receiving means and for outputting its discriminating results; and

record control means for selectively recording corresponding digital speaking information on the basis of said discriminating results output by said speaking information discriminating means from said digital communication information received by said information receiving means.

According to the present invention of claim 1, the logger machine is connected with communication machine which is comprised of speaking machine for transmitting and receiving digital speaking information and non-speaking machine for transmitting and receiving digital non-speaking information through transmission medium means, and the digital speaking information is discriminated from the digital communication information which is comprised of received digital speaking information and the digital non-speaking information so as to record. Therefore, the logger machine which can be used for IP telephones through information communication network, such as Internet, can be realized. This logger machine can selectively record digital speaking information which record is desirable without recording the digital non-speaking information which record is not desirable. Then, the logger machine is realistic one, capable of recording digital speaking information as much as possible in limited memory capacity.

The invention of claim 2 is the logger machine as set forth in claim 1, wherein said transmission medium means is local area network.

According to the present invention of claim 2, the transmission medium means is local area network, so the logger machine is directly connected with the local area network so as to selectively record speaking record.

The invention of claim 3 is the logger machine as set forth in claim 1, wherein said digital speaking information is comprised of voice information and image information.

According to the present invention of claim 3, digital speaking information includes voice information and image information. Then, the logger machine can be applied to the speaking machine, such as visual telephone.

The invention of claim 4 is the logger machine as set forth in claim 1, wherein said transmission medium means transmits said digital communication information by a packet having address information.

According to the present invention of claim 4, the packet transmitted by the transmission medium means is received, and digital speaking information of the speaking machine is detected on the basis of the address information in the packet so as to record. Then, the digital speaking information by the packet can be selectively recorded in such a state that the logger machine is directly connected with the transmission medium means transmitting the packet.

The invention of claim 5 is the logger machine as set forth in claim 4, wherein terminal discriminating information for differentiating said communication machines every terminal, is included in said address information, and said record control means records both said digital speaking information and said terminal discriminating information.

According to the present invention of claim 5, terminal discriminating information is included in the address information in the packet. So, the terminal discriminating information as to by which terminal the digital speaking information is can be recorded together with the digital speaking information.

The invention of claim 6 is the logger machine as set forth in claim 4, wherein said address information includes communication machine discriminating information for dividing said communication machines into said speaking machine and said non-speaking machine, and said speaking information discriminating means discriminates said digital speaking information on the basis of said communication machine discriminating information.

According to the present invention of claim 6, communication machine discriminating information is included in the address information, and communication machine is discriminated by the communication machine discriminating information. Then, as to whether it is digital speaking information by the speaking machine or not and the starting condition of the speaking machine can be discriminated. By doing so, the digital speaking information can be selectively recorded on the basis of the communication machine discriminating information.

The invention of claim 7 is the logger machine as set forth in claim 4, wherein said record control means records said digital speaking information with said packet as it is.

According to the present invention of claim 7, the digital speaking information can be recorded by the packet as it is. By doing so, the digital communication information can be searched and played back on the basis of the address information in the packet.

The invention of claim 8 is the logger machine as set forth in claim 4, wherein said record control means records said digital speaking information by decoding said packet.

According to the present invention of claim 8, the digital speaking information can be recorded by decoding. By doing so, the address information in a plurality of packets can be collected into one, and the capacity of the digital speaking information to be recorded can be reduced. Besides, since the capacity of the digital speaking information can be reduced, more digital speaking information can be recorded, and its search and playing back can be made easier.

The invention of claim 9 is logger equipment, comprising:

communication machine comprised of speaking machine capable of transmitting and receiving digital speaking information and non-speaking machine capable of transmitting and receiving digital non-speaking information;

transmission medium means capable of transmitting digital communication information; and

said logger machine in claim 1, said logger equipment further comprising:

said transmission medium means connected with said communication machine and said logger machine;

whereby said logger machine selectively records digital speaking information concerning said speaking machine from said digital communication information transmitted by said transmission medium means.

According to the present invention of claim 9, the digital speaking information which record is desirable can be selectively recorded by the present logger machine from the transmission medium means by which digital communication information is transmitted without recording digital non-speaking information which record is not desirable.

### BRIEF DESCRIPTION OF THE DRAWINGS

FIG. 1 is a conceptual figure showing conventional logger equipment;

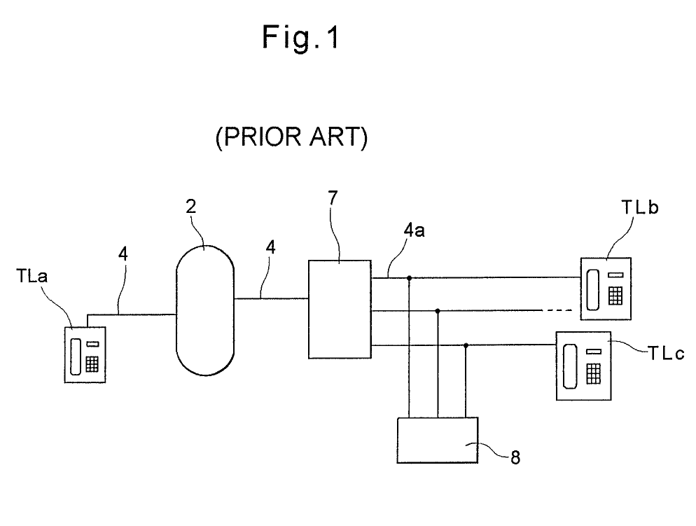

FIG. 2 is a conceptual figure showing an example of the present logger equipment;

FIG. 3 is a conceptual figure showing a packet;

FIG. 4 is a block diagram showing an example of a structure of logger machine;

FIG. 5 is a conceptual figure showing an IP telephone set connected with LAN; and

FIG. 6 is a block diagram showing an example of the structure of the other logger machine.

### DESCRIPTION OF THE PREFERRED EMBODIMENT

A conventional logger equipment 8 is connected in a telephone line, and records, searches for, and plays back only voice information. The logger equipment according to the present invention is connected with LAN that is an example of transmission medium means, and records voice information, or image information and another information if necessary from various information on LAN. The present logger equipment will now be explained based on the drawings hereinafter.

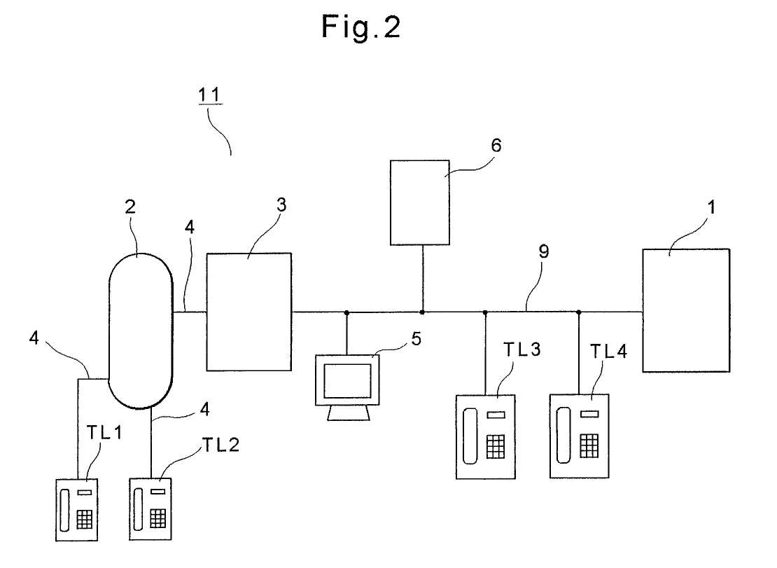

FIG. 2 is a conceptual figure showing a present logger equipment 11. As shown in FIG. 2, a plurality of telephone sets (for example, telephone set TL1, TL2) are connected with a public telephone line 2, and an IP private telephone switching machine 3, that is installed in companies or the like, is connected with the public telephone line 2. LAN 9 is connected with the IP private telephone switching machine 3. On the LAN 9, a non-speaking machine (a computer 5, a server 6, etc.), a plurality of IP telephone sets, such as IP telephone sets TL3 and TL4, which are examples of speaking machines, are connected, and furthermore, a logger machine 1 is connected therewith. The logger machine 1 will now be explained hereinafter in detail.

### The First Embodiment

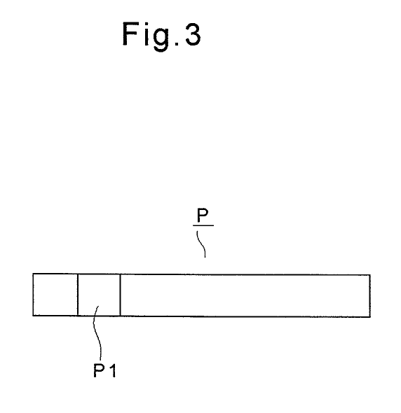

As stated above, the logger machine 1 is connected on the LAN 9 by Ethernet (CSMA/CD) based on TCP/IP. On the LAN 9, digital speaking information of conversation to be picked up (only “speaking information” hereinafter), such as voice information, image information, and various digital non-speaking information, such as www information (only “non-speaking information” hereinafter) , are running through. FIG. 3 is a conceptual figure showing a packet. Information running through on LAN 9 is divided into packets P as shown in FIG. 3. Various kinds of information on the LAN 9 runs through on the LAN 9, mixing many packets P. In a part of each packet P, an address information P1 is included, and in the address information P1, port number, IP address, MAC address and so on, which are examples of terminal identification information, are entered.

For example, when a conversation starts between the telephone set TL1 and IP telephone set TL4 in the FIG. 2, the telephone set TL1, the public telephone line 2 and the IP private telephone switching machine 3 are connected with one another through a telephone line 4 by a line switching method, and protocol conversion is performed at the IP private telephone switching machine 3, and the IP private telephone switching machine 3 and the IP telephone set TL4 are connected with each other through the LAN 9 by a packet method. Then, on the LAN 9, the voice information during conversation runs through, mixing with the non-speaking information from the computer 5 and the like. And, all the information on the LAN 9 streams to the logger machine 1 connected with the LAN 9. The information streamed to the logger machine 1 is processed as shown below.

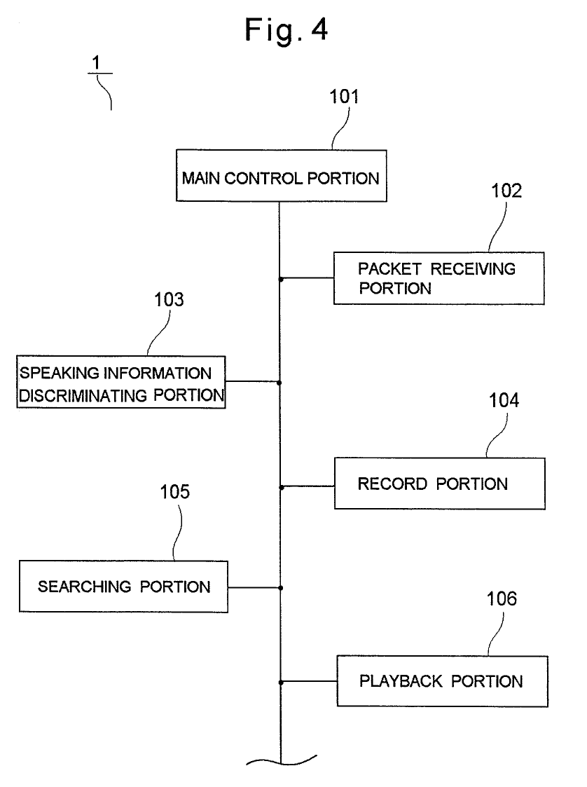

FIG. 4 is a block diagram showing a structure of the logger machine 1. As shown in FIG. 4, the logger machine 1 is comprised of a main control portion 101, a packet receiving portion 102 that is an example of information receiving means, a speaking information discriminating portion 103 that is an example of discriminating means of the speaking information, a record portion 104 that is an example of record control means, a searching portion 105, and a playback portion 106. As mentioned above, when all the information of the LAN 9 is input, at first, each packet P is separately received by the packet receiving portion 102. The received packet P is transferred to the speaking information discriminating portion 103, and discrimination is made whether it is the speaking information or not on the basis of the address information P1. The speaking information discriminating portion 103 holds a database file memorizing address of the speaking machine connected with the LAN 9, such as an IP telephone set (IP address or MAC address). For example, discrimination whether a packet P is the speaking information or not is performed by the presence of the address information P1 in the data base file. When the discrimination is that the packet P is not speaking information (that is, non-speaking information) , the main control portion 101 deletes the packet P. If it is discriminated as speaking information on the basis of the address information P1 of the packet P, its record is instructed on the basis of the discrimination result. Receiving this, the record portion 104 records the packet P as it is. That is, all of the speaking information is recorded with the state of the packet P, and the packet P which is not the speaking information is deleted, and then, extra record is not necessary.

When the recorded speaking information is played back, the address of the objective IP telephone set is input through an input means that is not shown (Since an address corresponds to an extension number of a telephone one to one, an extension number may be input and the address converted from the extension number may be used). The searching portion 105 searches from all of the recorded packets P on the basis of the address information P1, which these packets P have, with the input address as a key, and transfers a plurality of packets P searched to the playback portion 106. The playback portion 106 restructures (decodes) a plurality of packets P searched in order, and converts only speaking information removed the information, such as the address information P1 into voice, for instance, and plays back through an output means, such as a speaker (not shown). Furthermore, the information, such as date, time may be added at the time of recording, and at the time of playing back, the speaking information may be searched by the date and the time so as to play back.

As stated above, by the logger machine 1 connected on LAN 9, the conversation of the IP telephone set TL4 can be recorded, and the conversation to be heard can be searched and played back. And, the speaking machine is not always the IP telephone TL4, but any machine possible to speak, connected on the LAN 9 is sufficient. For example, the telephone installing a microphone and a speaker on the computer 5 may be used.

Besides, in the above-mentioned embodiment, the packet P of voice information of speaking information is discriminated by the speaking information discriminating portion 103 and is recorded by the record portion 104. However, in case of a conversation by a visual telephone or the like for example, image information can be also discriminated and can be also recorded as well as voice information. And as a result, the voice and the image can be searched and played back. It is possible to add another various information (caller number notification information or telephone charges notificatio information and others) to the speaking information.

### The Second Embodiment

In the first embodiment, the speaking information is discriminated by the address information P1 of the packet P, but in this embodiment, a method of discriminating of information is changed.

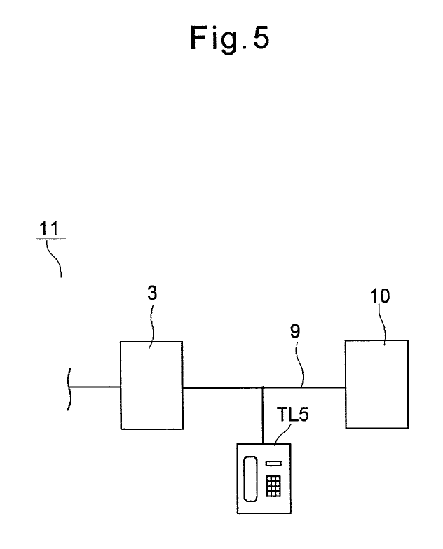

FIG. 5 is a conceptual figure showing an IP telephone set TL5 connected with the LAN 9. As shown in FIG. 5, the IP telephone set TL5 and a logger machine 10 are connected with the LAN 9 connected with the IP private telephone switching machine 3. For example, in the LAN 9, a port number is set in order to distinguish information of each application, such as HTTP, FTP from one another. And, for the speaking information exchanged between the IP telephone set TL5 and the IP private telephone switching machine 3, a fixed port number XX is set in order to distinguish from another kind of information. The port number XX is included in the address information P1 of the packet P concerning the speaking information.

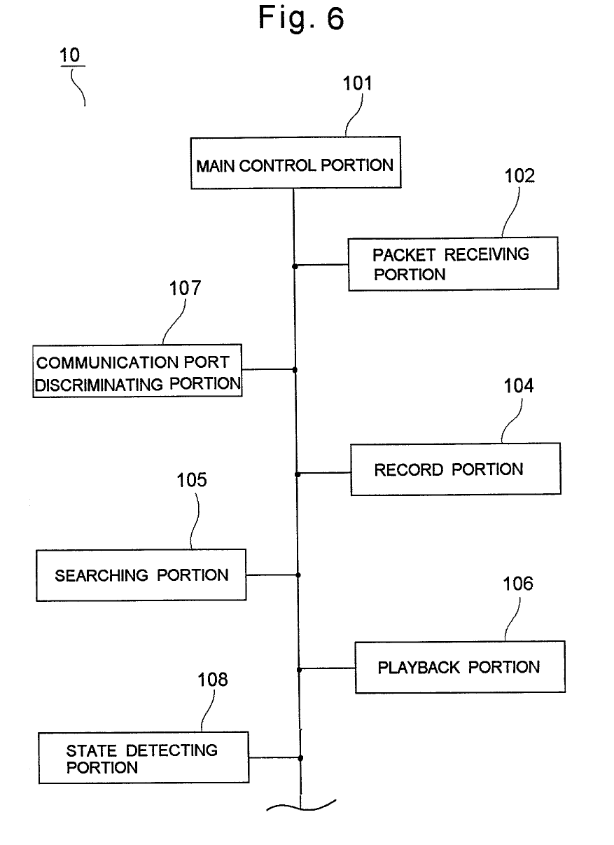

A first method using the port number XX will be explained. That is, the packet P is received by the packet receiving portion 102, and the port number is detected from the address information P1 of the received packet P by a communication port discriminating portion 107 in FIG. 6, and discrimination is executed as to whether the port number is the port number XX of the speaking information or not. As a result of this discrimination, if it is the port number XX of the speaking information, its recording is instructed to the record portion 104 since the received packet P is the speaking information. And as a result of the discrimination, if it is not the port number XX of the speaking information, the received packet P is the non-speaking information, and it is unnecessary to record and it is deleted. By this method, it is needless to have a data base file memorizing address of the IP telephone set and its search and reference is not necessary at the time of the discrimination. Then, it is easy to construct a control program, and the load on the machine is decreased, conveniently.

A second method using the port number XX will now be explained. That is, a state detecting portion 108 shown by two dot chain line in FIG. 6, detects a port operating state of the application for providing speaking service of the IP telephone set TL5 or the IP private telephone switching machine 3 by communication taking use of the LAN 9. If the detection is that the port is open (in operation) it is in the state of speaking, so the record portion 104 records the packet P received by the packet receiving portion 102. If the detection is that the port is closed (in stop state), there is no speaking, so the packet P received by the packet receiving portion 102 is deleted. According to this method, the non-speaking information received at the time of receiving the speaking information, is also recorded, but, it is needless to discriminate the received each packet P. Then, in comparison with the method above-mentioned, control program is made more simple and the load on the machine is widely reduced.

On this occasion, the search and playback of the recorded speaking information is the same as the first embodiment, so the explanation is omitted.

### Another Embodiment

As stated above, in the first and second embodiments, the record portion 104 records the packet Pas it is transferred, the searching portion 105 searches the packet P to be played back, and the playback portion 106 reconstitutes (decodes) in order so as to play back. By doing so, the voice information, the image information and the like, which is divided in a plurality of packets P, are converted into sound, image and the like by reconstituting (decoding). But, the packets P transferred may be reconstituted (be decoded) in order at the time of record, and may be converted in sound, image and the like so as to record, search and play back. Then, the address information P1 included in each packet, such as the IP address, the port number and the MAC address, can be made one information so as to reduce the capacity necessary for recording. Therefore, more sound and image and the like can be recorded. Besides, the volume for searching can be reduced in case where the collected sound and image is searched in comparison with the case of searching the packets P recorded in large amount, and searching and playing back can be effectively easily performed.

In the first and second embodiments, the conversation between the telephone set TL1 connected with the public telephone line 2 and the IP telephone set TL4, that is, the conversation of line wire is recorded and played back, as shown in FIG. 2, for instance. But, the conversation between the IP telephone set TL3 and the IP telephone set TL4, for instance, that is, the conversation of extension telephone can be also recorded, searched and played back. That is, the voice information, the image information and the like on the LAN 9 can be freely recorded and played back according to the present logger equipment.

In the above-mentioned first and second embodiments, the logger machines 1 and 10 are connected Local Area Network (LAN). But, the network to be connected may be Wide Area Network (WAN) including the Internet. In this case, the logger machine, the IP telephone set and the private telephone switching machine are not always present in the same sub network. And, the above-mentioned private telephone switching machine is not necessary in case where the speaking through the telephone line of line switching method is not necessary.

Besides, the above-mentioned first and second embodiments refer to the method of transferring speaking information by a packet as one of examples. But, as long as such information can be transferred in the shape of digital data including address information, the method is not limited to the packet switching method. In addition to this method, data switching method, such as message switching method can be adopted.

Besides, the above-mentioned embodiments refer to the network by TCP/IP protocol. But, the network protocol to be used may be another network protocol, such as IPX and SNA. And, in the above-mentioned embodiments, the transferring control method is CSMA/CD method. But, in addition to this method, various methods, such as talken passing method and ATM method, can be adopted. In any case, such connection form that all of the data on network is transferred to the logger machines 1, 10, may be sufficient.

The embodiments which are described in the present specification are illustrative and not limiting. The scope of the invention is designated by the accompanying claims and is not restricted by the descriptions of the specific embodiments. Accordingly, all the transformations and changes belonging to the claims are included in the scope of the present invention.

1. Logger machine, with which communication machine, which is comprised of speaking machine capable of transmitting and receiving digital speaking information and non-speaking machine capable of transmitting and receiving digital non-speaking information, is connected, to be connected with transmission medium means, capable of transmitting digital communication information, such logger machine comprising:
information receiving means for receiving digital communication information transferred from said transmission medium means;
speaking information discriminating means for discriminating said digital speaking information from said digital communication information received by said information receiving means and for outputting its discriminating results; and
record control means for selectively recording corresponding digital speaking information on the basis of said discriminating results output by said speaking information discriminating means from said digital communication information received by said information receiving means.

2. The logger machine as set forth in claim 1, wherein said transmission medium means is local area network.

3. The logger machine as set forth in claim 1, wherein said digital speaking information is comprised of voice information and image information.

4. The logger machine as set forth in claim 1, wherein said transmission medium means transmits said digital communication information by a packet having address information.

5. The logger machine as set forth in claim 4, wherein terminal discriminating information for differentiating said communication machines every terminal, is included in said address information, and said record control means records both said digital speaking information and said terminal discriminating information.

6. The logger machine as set forth in claim 4, wherein said address information includes communication machine discriminating information for dividing said communication machines into said speaking machine and said non-speaking machine, and said speaking information discriminating means discriminates said digital speaking information on the basis of said communication machine discriminating information.

7. The logger machine as set forth in claim 4, wherein said record control means records said digital speaking information with said packet as it is.

8. The logger machine as set forth in claim 4, wherein said record control means records said digital speaking information by decoding said packet.

9. Logger equipment, comprising:
communication machine comprised of speaking machine capable of transmitting and receiving digital speaking information and non-speaking machine capable of transmitting and receiving digital non-speaking information;
transmission medium means capable of transmitting digital communication information; and
said logger machine in claim 1, said logger equipment further comprising:
said transmission medium means connected with said communication machine and said logger machine;
whereby said logger machine selectively records digital speaking information concerning said speaking machine from said digital communication information transmitted by said transmission medium means.
